(19) United States
(12) Patent Application Publication
(10) Pub. No.: US 2013/0044398 A1
(43) Pub. Date: Feb. 21, 2013

(54) INFORMATION PROCESSING UNIT AND INFORMATION PROCESSING APPARATUS

(71) Applicant: Takahiro MIYAZAKI, Kawasaki (JP)

(72) Inventor: Takahiro MIYAZAKI, Kawasaki (JP)

(73) Assignee: FUJITSU LIMITED, Kawasaki-shi (JP)

(21) Appl. No.: 13/537,360

(22) Filed: Jun. 29, 2012

(30) Foreign Application Priority Data
Aug. 17, 2011 (JP) 2011-178622

(51) Int. Cl. H02H 9/04; H02H 9/00

(52) U.S. Cl. 361/56; 361/54

(57) ABSTRACT

An information processing unit is disclosed that includes a load circuit, a pair of terminals that are capable of being connected to and removed from a direct current power source, a first capacitor connected between power terminals of the load circuit, a rush current suppressing circuit configured to suppress rush current flowing from the direct current power source to the first capacitor or the load circuit via the terminals, a buffer circuit connected between the terminals and buffers voltage fluctuation between the terminals, a second capacitor connected in series with the rush current suppressing circuit and the first capacitor in a line parallel to the buffer circuit, a switch connected parallel to the second capacitor, and a first controller configured to turn on the switch when a designated period of time is elapsed after hot insertion of the terminals into the direct current power source.

### CROSS-REFERENCE TO RELATED APPLICATIONS

This patent application is based upon and claims the benefit of priority of the prior Japanese Patent Application No. 2011-178622 filed on Aug. 17, 2011, the entire contents of which are incorporated herein by reference.

### FIELD

The embodiments discussed herein are related to an information processing unit and an information processing apparatus.

### BACKGROUND

There is a server known in the art. Such a server can be easily expanded by installing a blade server into a rack type chassis of the server. The blade server can be easily removed from the chassis.

FIG. 1 is a block diagram illustrating a server including plural blade servers.

A server 1 includes a chassis 10 and blade servers 20-1 to 20-N. N stands for natural number greater than or equal to two. The chassis 10 includes a direct current power source 11, terminals 12A-1 to 12A-N, terminals 12B-1 to 12B-N and wirings 13.

The direct current power source 11 is a type of a power source which generates direct current power of a designated voltage. The direct current power generated by the direct current power source 11 is supplied to the blade servers 20-1 to 20-N. The direct current power source 11 is connected to the terminals 12A-1 to 12A-N and 12B-1 to 12B-N via the wirings 13.

The terminals 12A-1 to 12A-N and 12B-1 to 12B-N constitute N-pairs of terminals to which the blade servers 20-1 to 20-N are connected, respectively. The terminals 12A-1 to 12A-N are connected parallel to a positive terminal of the direct current power source 11 with each other via the wirings 13. The terminals 12B-1 to 12B-N are connected parallel to a negative terminal of the direct current power source 11 with each other via the wirings 13.

As terminals 21A-1 to 21A-N and 21B-1 to 21B-N of the blade servers 20-1 to 20-N are inserted into the terminals 12A-1 to 12A-N and 12B-1 to 12B-N, respectively, the blade servers 20-1 to 20-N are connected to the direct current power source 11 of the chassis 10. In this condition, the blade servers 20-1 to 20-N can receive direct current power from the direct current power source 11.

The wirings 13 connect the direct current power source 11 and the terminals 12A-1 to 12A-N and 12B-1 to 12B-N, in the chassis 10.

The blade servers 20-1 to 20-N include the terminals 21A-1 to 21A-N and 21B-1 to 21B-N and load circuits 22-1 to 22-N, respectively. As the load circuits 22-1 to 22-N receive the direct current power from the direct current power source 11 via the terminals 21A-1 to 21A-N and 21B-1 to 21B-N, the load circuits 22-1 to 22-N become a state in that the load circuits 22-1 to 22-N can operate. The load circuits 22-1 to 22-N include Central Processing Units (CPU) and memories, respectively, for example.

Each of the blade servers 20-1 to 20-N can be installed into the chassis 10 and be removed from the chassis 10 freely. Therefore, in the server 1, it is possible to add or remove the blade servers 20-1 to 20-N as one chooses.

As described above, it is possible to install the blade servers 20-1 to 20-N into the chassis 10 or to remove the blade servers 20-1 to 20-N from the chassis 10 freely and randomly. The blade servers 20-1 to 20-N have similar configuration with each other.

Accordingly, in a case where the blade servers 20-1 to 20-N are indiscriminate, the blade servers 20-1 to 20-N are referred to as the blade server(s) 20. Similarly, in a case where the terminals 21A-1 to 21A-N are indiscriminate, the terminals 21A-1 to 21A-N are referred to as the terminal(s) 21A. In a case where the terminals 21B-1 to 21B-N are indiscriminate, the terminals 21B-1 to 21B-N are referred to as the terminal(s) 21B. In a case where the load circuits 22-1 to 22-N are indiscriminate, the load circuits 22-1 to 22-N are referred to as the load circuit(s) 22.

In order to stabilize electric power which is supplied to the load circuit 22 of the blade server 20 as described above, it may be conceivable that a capacitor is connected parallel to the load circuit 22. The capacitor is connected parallel to the load circuit 22 between the terminals 21A and 21B.

However, rush current flows through the capacitor and the load circuit 22 of the blade server 20 when the blade server 20 is installed into the chassis 10.

In order to suppress the rush current flowing in the blade server 20, it may be conceivable that a rush current suppressing circuit which suppresses the rush current flowing through the capacitor and the load circuit 22 is inserted between the capacitor and the terminal 21A or between the capacitor and the terminal 21B. The rush current suppressing circuit may be realized by a circuit including a field effect transistor (FET), for example.

When the blade server 20 is being connected to (installed into) the chassis 10, the FET of the rush current suppressing circuit is gradually turned on and suppresses the rush current flowing through the capacitor and the load circuit 22.

By the way, the FET of the rush current suppressing circuit has a parasitic capacitance. The wirings 13 of the chassis 10 have internal resistance and parasitic inductance.

Therefore, when the blade server 20 including the capacitor and the rush current suppressing circuit is being installed into the chassis 10 while other blade server(s) 20 is (are) installed into the chassis 10 and is (are) in operation, voltage fluctuation (resonance) may occur. Such a voltage fluctuation (resonance) may be caused by an LC circuit which is constituted by the parasitic inductance of the wirings 13 of the chassis 10, the capacitor and the parasitic capacitance of the FET of the rush current suppressing circuit. Hereinafter, an action that “the blade server 20 including the capacitor and the rush current suppressing circuit is being installed into the chassis 10 while other blade server(s) 20 is (are) installed into the chassis 10 and is (are) in operation” is referred to as “hot insertion”. The hot insertion is a part of an action of “hot plug” which includes actions of installing and replacing of the blade server 20 without interrupting system operation. Due to the voltage fluctuation (resonance), the voltage in the blade server 20 which is connected to the chassis 10 may rise up to a value that is almost twice as high as input voltage which is input to the blade server 20 from the chassis 10.

Since the voltage fluctuation (resonance) may be propagated to other blade server (s) 20 that is (are) being connected to the chassis 10, the voltage fluctuation (resonance) may cause false operation or damage of other blade server(s) 20.

Herein, it may be conceivable that a load circuit or the like having a withstand voltage which is more than twice as high as that of the load circuit 22 is included in the blade server 20 instead of the load circuit 22 or the like. However, due to miniaturization of elements or the like caused by downsizing in recent years, the withstand voltage of elements is decreasing. Further, considering the voltage fluctuation (resonance), voltage margin of the element approaches the limit. Accordingly, increase in manufacturing cost is unavoidable in order to obtain an adequate voltage margin by increasing the withstand voltage of the element.

Herein, in order to suppress the voltage fluctuation (resonance) which occurs at the time of the hot insertion of the blade server 20, it may be conceivable that resistance component of the wiring 13 of the chassis 10 is increased or a resistor is added into the blade server 20, for example. However, these techniques result in increase of power loss, voltage drop or the like. Thus, these techniques are not effective solutions.

Alternatively, it may be conceivable that a switch is connected parallel to the resistor added into the blade server 20, and that the switch is turned on in order to bypass the resistor when the resistor is not necessary in an electric circuit of the blade server 20. The switch may be realized by a switching element such as an FET or the like. However, there may be a case where the voltage fluctuation (resonance) is not suppressed effectively by the resistor added into the blade server 20 because of a floating capacitance of the switch. In this case, the floating capacitance of the switch affects the electric circuit of the blade server 20 even when the switch is turned off. Thus, the technique of adding the switch as described above is not an effective solution.

Alternatively, it may be conceivable that a dumping circuit which is realized by a series circuit of a capacitor and a resistor is inserted between the terminals 21A and 21B of the blade server 20 in order to suppress the voltage fluctuation (resonance) as described above.

The dumping circuit has impedance lower than combined impedance of the capacitor connected parallel to the load circuit 22 and the FET of the rush current suppressing circuit. The electric power of the voltage fluctuation (resonance) is consumed by the resistor of the dumping circuit. Thus the dumping circuit suppresses the voltage fluctuation (resonance).

However, the parasitic inductance of the wirings 13 becomes smaller and resonance frequency of the voltage fluctuation (resonance) becomes higher in a case where lengths of the wirings 13 becomes shorter by downsizing the chassis 10. Therefore, there may be a case where the impedance of the dumping circuit becomes greater than the combined impedance of the capacitor connected parallel to the load circuit 22 and the FET of the rush current suppressing circuit.

Further, the parasitic inductance of the wirings 13 depends largely on materials, widths, lengths or the like or the wirings 13. Therefore, it is not easy to set the impedance of the dumping circuit in relation to the combined impedance of the capacitor connected parallel to the load circuit 22 and the FET of the rush current suppressing circuit.

In such a case, there is a problem in that it is not possible to suppress the voltage fluctuation (resonance) even though the dumping circuit is inserted between the terminals 21A and 21B of the blade server 20 at the time of the hot insertion of the blade server 20 into the chassis 10.

### PRIOR ART REFERENCES

### Patent References

[Patent Document 1] Japanese Patent Application Publication No. 2001-230865
[Patent Document 2] Japanese Patent Application Publication No. 10-066345
[Patent Document 3] Japanese Patent Application Publication No. 04-037194
[Patent Document 4] Japanese Patent Application Publication No. 2007-159395

### SUMMARY

According to an aspect of an embodiment, there is provided an information processing unit including a load circuit, a pair of terminals that are capable of being connected to and removed from a direct current power source, a first capacitor configured to be connected between power terminals of the load circuit, a rush current suppressing circuit configured to suppress rush current flowing from the direct current power source to the first capacitor or the load circuit via the pair of the terminals, a buffer circuit configured to be connected between the pair of the terminals and to buffer voltage fluctuation between the pair of the terminals, a second capacitor configured to be connected in series with the rush current suppressing circuit and the first capacitor in a line parallel to the buffer circuit, a switch configured to be connected parallel to the second capacitor, and a first controller configured to turn on the switch when a designated period of time has elapsed after hot insertion of the pair of the terminals into the direct current power source.

The object and advantages of the invention will be realized and attained by means of the elements and combinations particularly pointed out in the appended claims.

It is to be understood that both the foregoing general description and the following detailed description are exemplary and explanatory and are not restrictive of the invention as claimed.

### BRIEF DESCRIPTION OF THE DRAWINGS

FIG. 1 is a block diagram illustrating a server including plural blade servers;

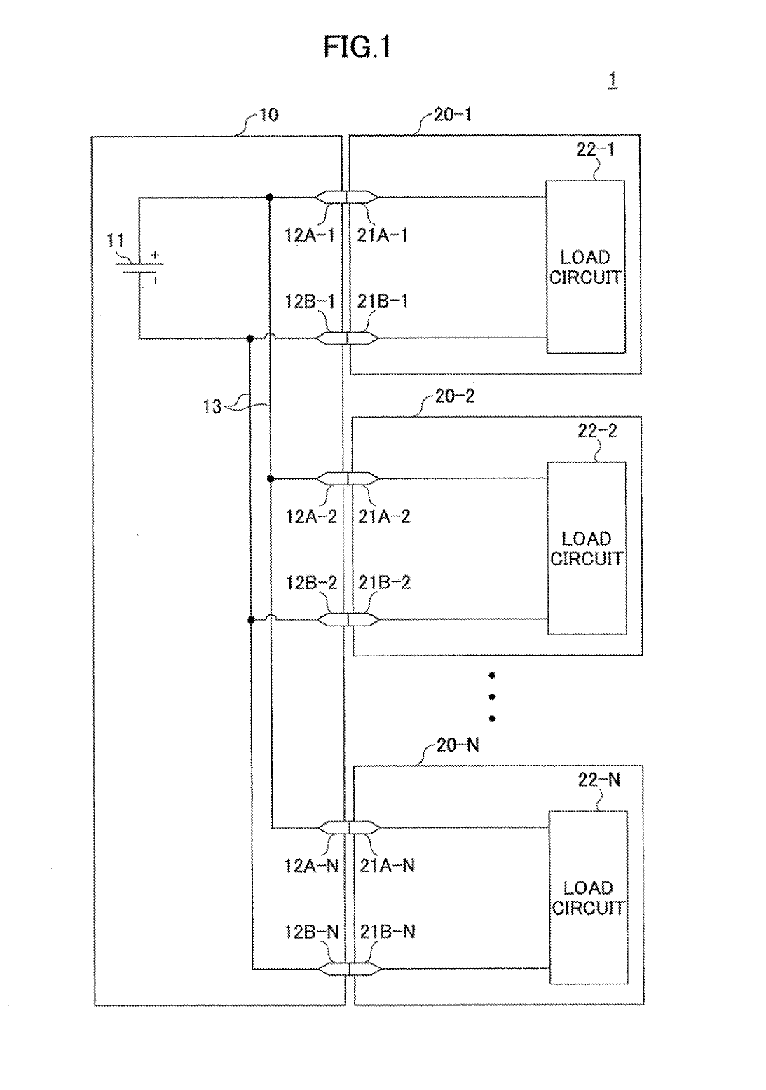

FIG. 2 is an oblique perspective diagram illustrating a server of an embodiment;

FIG. 3 is a diagram illustrating a circuit configuration of the server of the embodiment;

FIG. 4 is a diagram illustrating an internal configuration of a load circuit included in each of blade servers of the server of the embodiment;

FIG. 5 is a diagram illustrating a circuit configuration of the blade server of the embodiment;

FIG. 6 is a time chart illustrating time evolutions of voltages of some elements included in the blade server at the time of hot insertion of the blade server into a chassis;

FIG. 7 illustrates simulation results of frequency characteristics of impedance of a dumping circuit, combined impedance of capacitors of the blade server of the embodiment and combined impedance of capacitors of a comparative blade server; and

FIG. 8 is a diagram illustrating a time evolution of voltage fluctuation (resonance) characteristics of the comparative blade server.

### DESCRIPTION OF EMBODIMENTS

A description is given, with reference to the accompanying drawings, of embodiments of an information processing unit and an information processing apparatus.

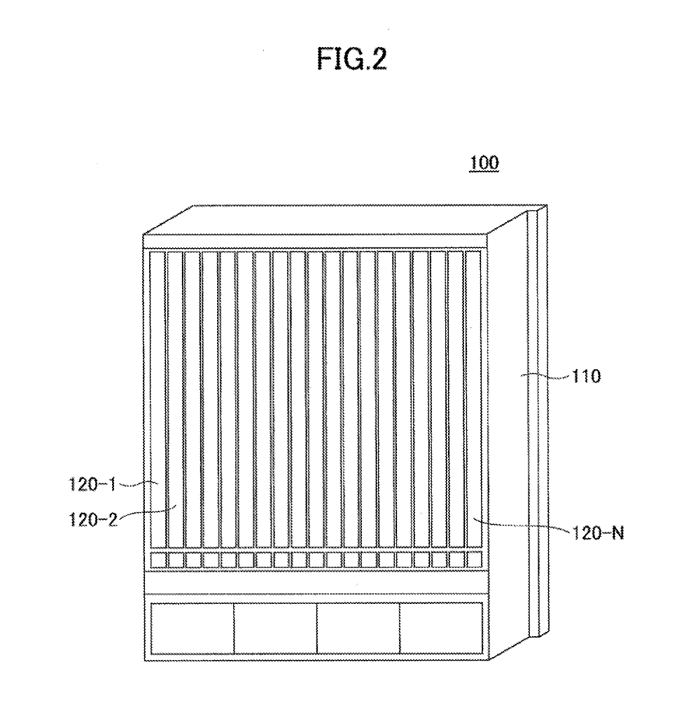

FIG. 2 is an oblique perspective diagram illustrating a server 100 of the embodiment.

The server 100 includes a chassis 110 and blade servers 120-1, 120-2, . . . , 120-N. Hereinafter, the blade servers 120-1, 120-2, . . . , 120-N are referred to as the blade servers 120-1 to 120-N. Hereinafter, N stands for a natural number greater than or equal to two.

The chassis 110 is a type of a rack housing which includes N racks (holes) into which respective blade servers 120-1 to 120-N may be installed. The chassis 110 includes a direct current power source and N pairs of terminals. The direct current power source supplies direct current power to the blade servers 120-1 to 120-N via the N pairs of the terminals.

FIG. 2 illustrates the server 100 in a state where the blade servers 120-1 to 120-N are installed into the N racks of the chassis 110, respectively. The blade servers 120-1 to 120-N receive the direct current power from the direct current power source via the terminals of the chassis 110 in a state where the blade servers 120-1 to 120-N are installed into the N racks of the chassis 110, respectively.

Each of the blade servers 120-1 to 120-N can be installed into the chassis 110 and be removed from the chassis 110 freely. Therefore it is possible to add or remove the blade servers 120-1 to 120-N as one chooses, in accordance with usage of the server 100, for example. The blade servers 120-1 to 120-N receive the direct current power from the direct current power source which is disposed in the chassis 110 in a state where the blade servers 120-1 to 120-N are installed into the chassis 110.

Herein, each of the blade servers 120-1 to 120-N is one example of the information processing unit. The server 100 is one example of the information processing apparatus including plural of the information processing units.

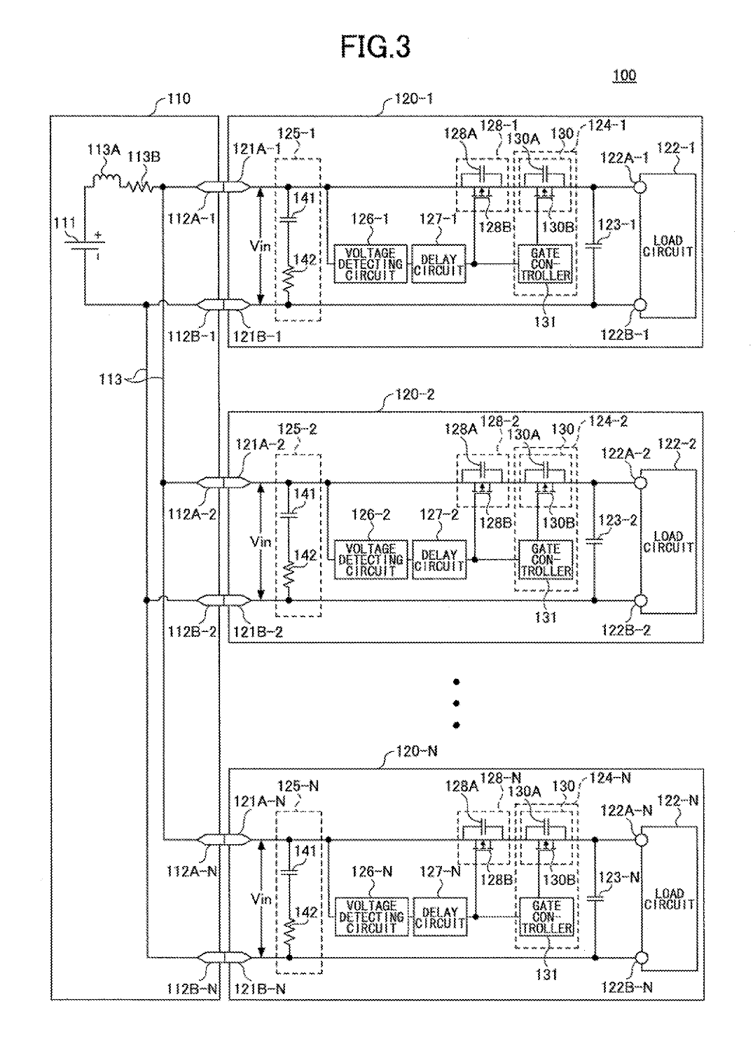

In the following, a circuit configuration of the server 100 will be described by referring to FIG. 3.

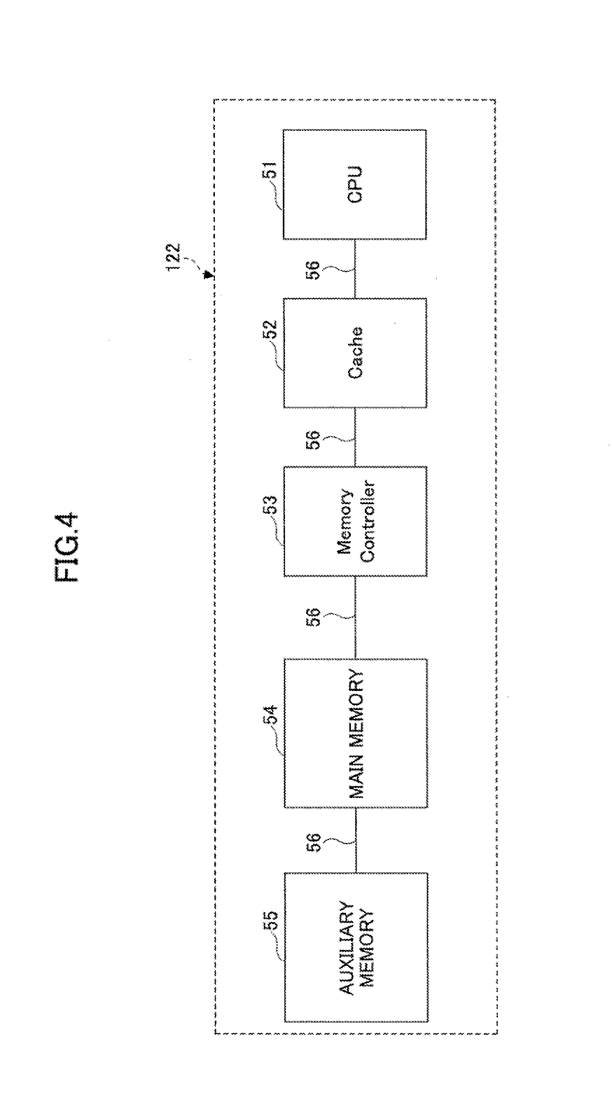

FIG. 3 is a diagram illustrating the circuit configuration of the server 100 of the embodiment. FIG. 4 is a diagram illustrating an internal configuration of a load circuit included in each of the blade servers 120-1 to 120-N of the server 100 of the embodiment.

The chassis 110 includes a direct current power source 111, N pairs of terminals 112A-1 to 112A-N and 112B-1 to 112B-N and wirings 113.

The direct current power source 111 may be a type of a power source which supplies direct current power that is converted by a rectifier circuit from alternating current power supplied from an alternating current power source. Alternatively, the direct current power source 111 may be a type of a direct power source such as a battery or the like. Output voltage of the direct current power source 111 is set at rated voltage of the blade servers 120-1 to 120-N, for example.

N pairs of the terminals 112A-1 to 112A-N and 112B-1 to 112B-N are disposed in the N racks (holes) of the chassis 110 as illustrated in FIG. 2, respectively. The terminals 112A-1 to 112A-N are connected to a positive terminal of the direct current power source 111 via the wirings 113. The terminals 112B-1 to 112B-N are connected to a negative terminal of the direct current power source 111 via the wirings 113.

In a state where the blade servers 120-1 to 120-N are installed into the N racks of the chassis 110, N pairs of terminals 121A-1 to 121A-N and 121B-1 to 121B-N of the blade servers 120-1 to 120-N are connected to the N pairs of the terminals 112A-1 to 112A-N and 112B-1 to 112B-N of the chassis 110, respectively.

The wirings 113 connect the terminals 112A-1 to 112A-N to the positive terminal of the direct current power source 111 and connect the terminals 112B-1 to 112B-N to the negative terminal of the direct current power source 111.

The wirings 113 include parasitic inductance and internal resistance. FIG. 3 illustrates a parasitic inductor 113A which represents the parasitic inductance of the wirings 113 and a resistor 113B which represents the parasitic resistance of the wirings 113 in an easy-to-understand manner. Combined impedance of the parasitic inductor 113A and the resistor 113B represents impedance of the wirings 113.

The blade servers 120-1 to 120-N include the N pairs of the terminals 121A-1 to 121A-N and 121B-1 to 121B-N and load circuits 122-1 to 122-N, respectively. The load circuits 122-1 to 122-N include N pairs of terminals 122A-1 to 122A-N and 122B-1 to 122B-N, respectively.

The blade servers 120-1 to 120-N further include capacitors 123-1 to 123-N, rush current suppressing circuits 124-1 to 124-N and dumping circuits 125-1 to 125-N, respectively.

The blade servers 120-1 to 120-N further include voltage detecting circuits 126-1 to 126-N, delay circuits 127-1 to 127-N and field effect transistors (FETs) 128-1 to 128-N, respectively.

In the present embodiment, the blade servers 120-1 to 120-N have the same configuration as described above.

Hereinafter, in a case where the blade servers 120-1 to 120-N are indiscriminate, the blade servers 120-1 to 120-N are referred to as the blade server(s) 120.

Similarly, in this context, the terminals 121A-1 to 121A-N and 121B-1 to 121B-N, the load circuits 122-1 to 122-N and the capacitors 123-1 to 123-N are referred to as the terminals 121A and 121B, the load circuit 122 and the capacitor 123, respectively. The rush current suppressing circuits 124-1 to 124-N, the dumping circuits 125-1 to 125-N, the voltage detecting circuits 126-1 to 126-N, the delay circuits 127-1 to 127-N and the FETs 128-1 to 128-N are referred to as the current suppressing circuit 124, the dumping circuit 125, the voltage detecting circuit 126, the delay circuit 127 and the FET 128, respectively. Accordingly, the blade server 120 includes the terminals 121A and 121B, the load circuit 122, the capacitor 123, the current suppressing circuit 124, the dumping circuit 125, the voltage detecting circuit 126, the delay circuit 127 and the FET 128. Similarly, hereinafter, the terminals 112A-1 to 112A-N and 112B-1 to 112B-N of the chassis 110 are referred to as the terminals 112A and 112B. The terminals 122A-1 to 122A-N and 122B-1 to 122B-N of the load circuits 122-1 to 122-N are referred to as the terminals 122A and 122B of the load circuit 122.

Although, as a matter of convenience, the blade servers 120-1 to 120-N are illustrated in FIG. 3, the number (N) of the blade servers 120 may be more than or equal to two.

In the following, the internal configuration of the blade server 120 will be described. The blade server 120 of the present embodiment suppresses the voltage fluctuation (resonance) between the terminals 121A and 121B when the blade server 120 is being installed into the chassis 110 while other blade server(s) 120 that is (are) installed into the chassis 110 is (are) powered from the chassis 110 and is (are) in operation.

For example, according to the present embodiment, the blade server 120-1 of the present embodiment suppresses the voltage fluctuation (resonance) between the terminals 121A-1 and 121B-1 when the blade server 120-1 is being installed into the chassis 110 while the blade server 120-2 that has been installed into the chassis 110 is powered from the chassis 110 and is in operation. Hereinafter, an action that “the blade server 120 is being installed into the chassis 110 while other blade server(s) 120 is (are) installed into the chassis 110 and is (are) in operation” is referred to as “hot insertion” of the blade server 120 (into the chassis 110). The hot insertion is a part of an action of “hot plug” which includes actions of install and replace of the blade server 120 without interrupting system operation.

The blade server 120 includes the terminals 121A and 121B, the load circuit 122, the capacitor 123, the current suppressing circuit 124, the dumping circuit 125, the voltage detecting circuit 126, the delay circuit 127 and the FET 128.

The terminals 121A and 121B are a pair of terminals that are capable of being connected to and removed from the terminals 112A and 112B of the chassis 110. The terminals 121A and 121B are used for receiving the direct current power from the chassis 110 and sending it to the blade server 120. The terminals 121A and 121B are connected to the terminals 122A and 122B of the load circuit 122, respectively. Hereinafter, voltage between the terminals 121A and 121B is referred to as input voltage Vin of the blade server 120.

The load circuit 122 includes a central processing unit (CPU) 51, a cache 52, a memory controller 53, a main memory 54 and an auxiliary memory 55. The CPU 51, the cache 52, the memory controller 53, the main memory 54 and the auxiliary memory 55 are connected to each other via dedicated system buses 56, for example. Herein, the load circuit 122 may include plural of the CPUs 51.

The cache 52 is a type of a memory which temporarily stores data which is used by the CPU 51 when the CPU 51 performs processing. A random access memory (RAM) may be used as the cache 52.

The memory controller 53 is a type of a controller which performs control of data which is read and written between the cache 52 and the main memory 54 based on a command output from the CPU 51.

The CPU 51, the cache 52 and the memory controller 53 may be realized by a large scale integration circuit (LSI), for example.

A read only memory (ROM) or a dynamic random access memory (DRAM) may be used as the main memory 54, for example. A hard disk may be used as the auxiliary memory 55, for example.

Herein, the load circuit 122 may include a data input/output port or the like which is used for communicating with an external apparatus.

The load circuit 122 is a part of the blade server 120 and performs information processing. A configuration of the load circuit 122 may not be limited to the configuration as illustrated in FIG. 4.

The capacitor 123 is one example of a first capacitor which is connected between the terminals 122A and 122B of the load circuit 122. The capacitor 123 is disposed for the sake of stabilizing the direct current power supplied from the terminals 121A and 121B to the load circuit 122.

The rush current suppressing circuit 124 is connected between one terminal (the upper terminal as illustrated in FIG. 3) of the capacitor 123 and the terminal 121A. The rush current suppressing circuit 124 is disposed for suppressing rush current flowing into the capacitor 123 and the load circuit 122 when the terminals 121A and 121B of the blade server 120 are connected to the terminals 112A and 112B at the time of the hot insertion of the blade server 120 into the chassis 110.

The rush current suppressing circuit 124 includes a P-type Metal Oxide Semiconductor Field Effect Transistor (MOSFET) 130 and a gate controller 131.

Since the FET 130 includes parasitic capacitance, the parasitic capacitance of the FET 130 is illustrated as a capacitor 130A, as a matter of convenience. The rest of the FET 130, i.e. a part of the FET 130 other than the capacitor 130A, is illustrated as a transistor part 130B, as a matter of convenience. The capacitor 130A is connected between a source and a drain of the transistor part 130B.

Herein, the FET 130 is one example of a first field effect transistor which is connected in series with the capacitor 123 and a parasitic capacitance 128A in a line parallel to the dumping circuit 125. The gate controller 131 is one example of a second controller which controls turning on/off of the FET 130.

The line parallel to the dumping circuit 125 is a line which is located on the right side of the dumping circuit 125 in FIG. 3 and forms a U-shaped line including the FET 128 and the capacitor 123.

The source of the transistor part 130B of the FET 130 is connected to a drain of the FET 128. The drain of the transistor part 130B is connected to the terminal 122A of the load circuit 122. A gate of the transistor part 130B is connected to an output terminal of the gate controller 131.

An input terminal of the gate controller 131 is connected to an output terminal of the delay circuit 127, and the output terminal of the gate controller 131 is connected to the gate of the transistor part 130B. The gate controller 131 controls gate voltage of the FET 130 so that the FET 130 is gradually turned on when a designated delay time provided by the delay circuit 127 is elapsed after the blade server 120 is installed into the chassis 110 at the time of the hot insertion. An exemplary concrete circuit configuration of the gate controller 131 will be described later.

The dumping circuit 125 includes a capacitor 141 and a resistor 142. The capacitor 141 and the resistor 142 are connected in series between the terminals 121A and 121B. In a case where an electrolytic capacitor, a tantalum capacitor or the like which has a high equivalent series resistance component is used as the capacitor 141, the dumping circuit 125 may not include the resistor 142.

The dumping circuit 125 is one example of a buffer circuit which buffers the voltage fluctuation (resonance) in a case where the voltage fluctuation (resonance) is caused by the parasitic inductor 113A of the wirings 113, the capacitor 123 and the capacitor 130A (the parasitic capacitance of the FET 130) at the time of the hot insertion of the blade server 120 into the chassis 110.

When the voltage fluctuation of the resonance occurs between the terminals 121A and 121B, fluctuation component of the voltage between the terminals 121A and 121B is consumed in the resistor 142 of the dumping circuit 125. Thus, the voltage fluctuation (resonancee) between the terminals 121A and 121B is buffered.

The voltage detecting circuit 126 is one example of a voltage detecting part which is located in the output side of the dumping circuit 125 (i.e. located on right side of the dumping circuit 125 in FIG. 3) and detects the input voltage Vin. The input voltage Vin of the blade server 120 is obtained between the terminals 121A and 121B. The output terminal of the voltage detecting circuit 126 is connected to an input terminal of the delay circuit 127. Herein, the voltage detecting circuit 126 may be located in the input side of the dumping circuit 125 (i.e. located on left side of the dumping circuit 125 in FIG. 3). In this case, the voltage detecting circuit 126 detects the input voltage Vin in the input side of the dumping circuit 125.

When the voltage detecting circuit 126 detects that the input voltage Vin reaches a designated voltage, the voltage detecting circuit 126 outputs a detection signal which indicates detection of increase of voltage. The detection voltage is input to the delay circuit 127. Detailed configuration of the voltage detecting circuit 126 will be described later.

The input terminal of the delay circuit 127 is connected to the output terminal of the voltage detecting circuit 126. The output terminal of the delay circuit 127 is connected to the gate of the FET 128 and an input terminal of the gate controller 131 included in the rush current suppressing circuit 124.

The delay circuit 127 is one example of a delay part which delays the detection signal output from the voltage detecting circuit 126 for a designated period of time and outputs the delayed detection signal. The delayed detection signal output from the delay circuit 127 is input to the gate of the FET 128 and the input terminal of the gate controller 131 included in the rush current suppressing circuit 124. Detailed configuration of the delay circuit 127 and the designated period of time will be described later.

Herein, the voltage detecting circuit 126 and the delay circuit 127 are one example of a first controller. The voltage detecting circuit 126 is one example of the voltage detecting part included in the first controller. The delay circuit 127 is one example of the delay part included in the first controller.

The FET 128 includes parasitic capacitance between the source and the drain. As a matter of convenience, the FET 128 is divided into a capacitor 128A and a transistor part 128B. The capacitor 128A represents the parasitic capacitance of the FET 128.

The capacitor 128A represents the parasitic capacitance between the source and the drain of the FET 128. The capacitor 128A is one example of a second capacitor which is connected in series with the rush current suppressing circuit 124 and the capacitor 123 in a line parallel to the dumping circuit 125. The line parallel to the dumping circuit 125 is a line which is located on the right side of the dumping circuit 125 in FIG. 3 and forms a U-shaped line including the rush current suppressing circuit 124 and the capacitor 123.

The capacitor 128A is connected between one terminal (the upper terminal as illustrated in FIG. 3) of the dumping circuit 125 and the source of the FET 130. Thus, the capacitor 128A is connected in series with the rush current suppressing circuit 124 and the capacitor 123 in the line parallel to the dumping circuit 125.

The capacitor 128A represents the parasitic capacitance between the source and the drain of the FET 128. In the present embodiment, the parasitic capacitance included in the FET 128 is represented as the capacitor 128A.

The transistor part 128B is one example of a switch which is connected parallel to the capacitor 128A that is one example of the second capacitor. The transistor part 128B is one example of a second field effect transistor as well.

Although the embodiment in which the parasitic capacitance of the FET 128 is represented as the capacitor 128A is described, a capacitor and a switch connected parallel to the capacitor may be used instead of the FET 128. In this case, for example, the transistor may be used as the switch, the capacitor may be connected between a collector and an emitter of the transistor, and a base of the transistor may be connected to the output terminal of the delay circuit 127.

As described above, the rush current suppressing circuit 124 is connected between one terminal (the upper terminal as illustrated in FIG. 3) of the capacitor 123 and the terminal 121A. However, the rush current suppressing circuit 124 may be connected between the other terminal (the lower terminal as illustrated in FIG. 3) of the capacitor 123 and the terminal 121B.

As described above, the source and the drain of the FET 128 is connected between the one terminal (the upper terminal as illustrated in FIG. 3) of the dumping circuit 125 and the source of the FET 130. However, the source and the drain of the FET 128 may be connected between the other terminal (the lower terminal as illustrated in FIG. 3) of the dumping circuit 125 and the other terminal (the lower terminal as illustrated in FIG. 3) of the capacitor 123. In this case, the rush current suppressing circuit 124 may be inserted between one terminal (the upper terminal as illustrated in FIG. 3) of the dumping circuit 125 and one terminal (the upper terminal as illustrated in FIG. 3) of the capacitor, or may be inserted between the FET 128 and the other terminal (the lower terminal as illustrated in FIG. 3) of the capacitor 123.

In the server 100 as illustrated in FIG. 3, position of the FET 128 and position of the rush current suppressing circuit 124 may be interchanged. Similarly, the rush current suppressing circuit 124 and the FET 128 may be connected between the other terminal (the lower terminal as illustrated in FIG. 3) of the dumping circuit 125 and the other terminal (the lower terminal as illustrated in FIG. 3) of the capacitor 123 in this order.

In any of these cases, the FET 128 is connected in series with the rush current 124 and the capacitor 123 in the line parallel to the dumping circuit 125.

In the following, a circuit configuration of the blade server 120 will be described by referring to FIG.

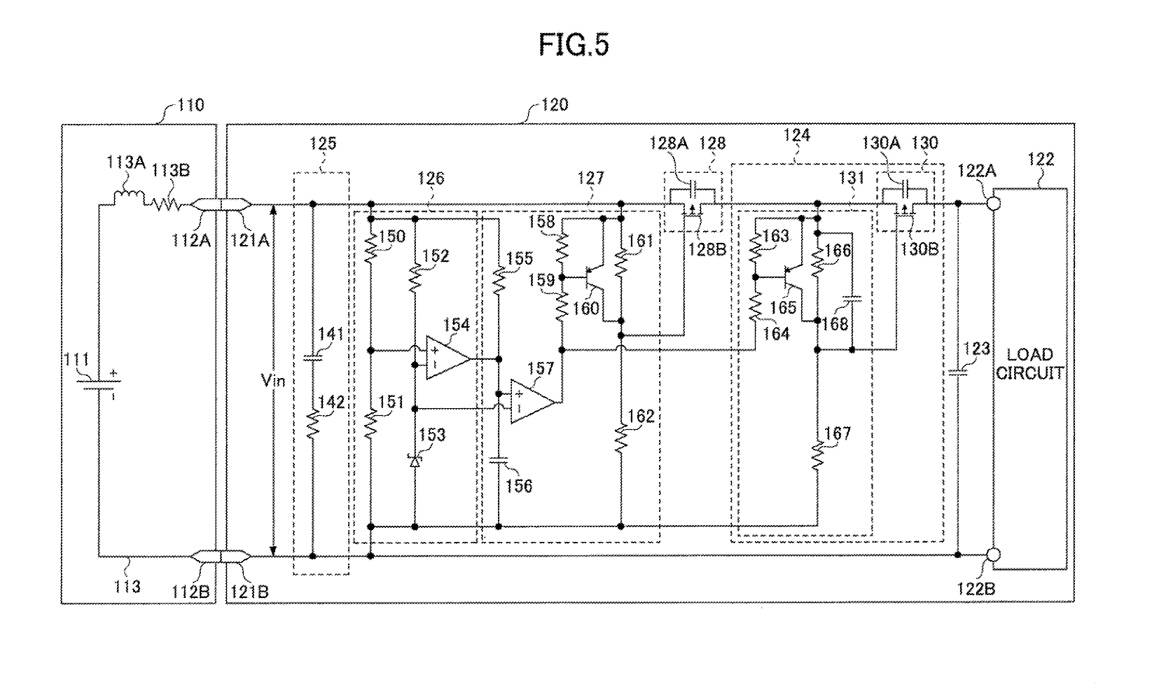

FIG. 5 is a diagram illustrating the circuit configuration of the blade server 120 of the embodiment.

FIG. 5 illustrates the detailed circuit configuration of the voltage detecting circuit 126, the delay circuit 127 and the gate controller 131 of the blade server 120.

The voltage detecting circuit 126 includes resistors 150, 151 and 152, a Zener diode 153 and a comparator 154.

The resistors 150 and 151 are used as a voltage dividing circuit which divides the input voltage Vin. One terminal (the upper terminal as illustrated in FIG. 5) of the resistor 150 is connected to the terminal 121A. The other terminal (the lower terminal as illustrated in FIG. 5) of the resistor 151 is connected to the terminal 121B. The midpoint which connects the other terminal (the lower terminal as illustrated in FIG. 5) of the resistor 150 and one terminal (the upper terminal as illustrated in FIG. 5) of the resistor 151 is connected to non-inverted input terminal of the comparator 154.

The resistor 152 and the Zener diode 153 are connected parallel to the resistors 150 and 151. One terminal (the upper terminal as illustrated in FIG. 5) of the resistor 152 is connected to the terminal 121A. The other terminal (the lower terminal as illustrated in FIG. 5) of the resistor 152 is connected to an output terminal of the Zener diode 153.

An input terminal of the Zener diode 153 is connected to the terminal 121B. The output terminal of the Zener diode 153 is connected to the other (the lower terminal as illustrated in FIG. 5) of the resistor 152. Accordingly, the Zener diode 153 has rectifying direction from the side on which the terminal 121B is located to the side on which the other terminal (the lower terminal as illustrated in FIG. 5) of the resistor 152 is located.

A connecting point which connects the other terminal (the lower terminal as illustrated in FIG. 5) of the resistor 152 and the output terminal of the Zener diode 153 is connected to an inverted input terminal of the comparator 154. The Zener diode 153 outputs a reference voltage which is input to the inverted input terminal of the comparator 154.

The non-inverted input terminal of the comparator 154 is connected to the midpoint between the resistors 150 and 151. The inverted input terminal of the comparator 154 is connected to the connecting point between the other terminal (the lower terminal as illustrated in FIG. 5) of the resistor 152 and the output terminal of the Zener diode 153. The output terminal of the comparator 154 is connected to the delay circuit 127.

Output of the comparator 154 changes from L level to H level when input voltage input to the non-inverted input terminal exceeds the reference voltage input to the inverted input terminal. The input voltage Vin is divided by the resistors 150 and 151, and then the divided voltage is input to the non-inverted input terminal of the comparator 154. H level output signal of the comparator 154 indicates that the input voltage Vin is increased to the designated voltage. The H level output signal constitutes the detection signal of the voltage detecting circuit 126.

The delay circuit 127 includes a resistor 155, a capacitor 156, a comparator 157, resistors 158 and 159, a transistor 160 and resistors 161 and 162.

The resistor 155 is connected in series with the capacitor 156. The resistor 155 and the capacitor 156 are connected parallel to a pair of the resistors 150 and 151 of the voltage detecting circuit 126 and a pair of the resistor 152 and the Zener diode 153, respectively. A connecting point between the resistor 155 and the capacitor 156 is connected to the output terminal of the comparator 154 and a non-inverted input terminal of the comparator 157.

The capacitor 156 is connected in series with the resistor 155. One terminal (the upper terminal as illustrated in FIG. 5) of the capacitor 156 is connected to the resistor 155. The other terminal (the lower terminal as illustrated in FIG. 5) of the capacitor 156 is connected to the terminal 121B.

The capacitor 156 sets the delay time of the delay circuit 127. The delay circuit 127 delays the H level output signal of the comparator 154 of the voltage detecting circuit 126 for the delay time set by the capacitor 156.

A non-inverted input terminal of the comparator 157 is connected to the connecting point between the resistor 155 and the capacitor 156. An inverted input terminal of the comparator 157 is connected to the connecting point between the resistor 152 and the Zener diode 153 of the voltage detecting circuit 126. The reference voltage is input to the inverted input terminal of the comparator 157 from the Zener diode 153 of the voltage detecting circuit 126.

The output terminal of the comparator 157 is connected to the other terminal (the lower terminal as illustrated in FIG. 5) of the resistor 159 and the rush current suppressing circuit 124.

The resistors 158 and 159 are connected in series with each other. One terminal (the upper terminal as illustrated in FIG. 5) of the resistor 158 is connected to the terminal 121A and an emitter of the transistor 160. The other terminal (the lower terminal as illustrated in FIG. 5) of the resistor 158 is connected to one terminal (the upper terminal as illustrated in FIG. 5) of the resistor 159 and a base of the transistor 160. Accordingly, the resistor 158 is connected between the base and the emitter of the transistor 160.

One terminal (the upper terminal as illustrated in FIG. 5) of the resistor 159 is connected to the other terminal (the lower terminal as illustrated in FIG. 5) of the resistor 158 and the base of the transistor 160. The other terminal (the lower terminal as illustrated in FIG. 5) of the resistor 159 is connected to the output terminal of the comparator 157.

The transistor 160 is a pnp-type transistor. The base of the transistor 160 is connected to the midpoint between the resistors 158 and 159. The emitter of the transistor 160 is connected to the terminal 121A and one terminal (the upper terminal as illustrated in FIG. 5) of the resistor 158. The collector of the transistor 160 is connected to the midpoint between the resistors 161 and 162.

The resistors 161 and 162 are connected in series with each other. One terminal (the upper terminal as illustrated in FIG. 5) of the resistor 161 is connected to the terminal 121A and the emitter of the transistor 160. The other terminal (the lower terminal as illustrated in FIG. 5) of the resistor 161 is connected to one terminal (the upper terminal as illustrated in FIG. 5) of the resistor 162 and the gate of the FET 128. Accordingly, the resistor 161 is connected between the emitter and the collector of the transistor 160.

One terminal (the upper terminal as illustrated in FIG. 5) of the resistor 162 is connected to the other terminal (the lower terminal as illustrated in FIG. 5) of the resistor 161, the collector of the transistor 160 and the gate of the FET 128. The other terminal (the lower terminal as illustrated in FIG. 5) of the resistor 162 is connected to the terminal 121B. Accordingly, the midpoint between the resistors 161 and 162 is connected to the gate of the FET 128.

When the H level output signal of the comparator 154 of the voltage detecting circuit 126 is input to the delay circuit 127, the capacitor 156 is charged and thereby the voltage between the terminals of the capacitor 156 is gradually increased. When the voltage between the terminals of the capacitor 156 exceeds the reference voltage of the comparator 157, the output voltage of the comparator 157 changes from L level to H level.

A period of time from the point when the charging of the capacitor 156 is started to the point when the voltage between the terminals of the capacitor 156 exceeds the reference voltage of the comparator 157 is set as the delay time of the delay circuit 127. The H level output signal of the comparator 154 of the voltage detecting circuit 126 is delayed for the delay time in the delay circuit 127.

The delay time may be set to be the designated delay time (the designated period of time) based on a relationship between signal level (voltage) of the H level output signal of the comparator 154 and capacitance of the capacitor 156.

When the output signal of the comparator 157 is changed from L level to H level, the pnp-type transistor 160 is turned off.

When the transistor 160 is turned on, the gate and the source of the FET 128 are short-circuited. Thus, the FET 128 is turned off. When the transistor 160 is turned off, voltage between the terminals of the resistor 161 is applied between the gate and the source of the FET 128. Thus, the FET 128 is turned on.

Accordingly, the FET 128 is turned on when the designated delay time is passed after the terminals 121A and 121B are connected to the terminals 112A and 112B of the chassis 110.

The rush current suppressing circuit 124 includes the FET 130 and the gate controller 131. The gate controller 131 includes resistors 163 and 164, a transistor 165, resistors 166 and 167 and a capacitor 168.

The resistors 163 and 164 are connected in series with each other. One terminal (the upper terminal as illustrated in FIG. 5) of the resistor 163 is connected to the terminal 121A, an emitter of the transistor 165, one terminal (the upper terminal as illustrated in FIG. 5) of the resistor 166 and one terminal (the upper terminal as illustrated in FIG. 5) of the capacitor 168. The other terminal (the lower terminal as illustrated in FIG. 5) of the resistor 163 is connected to one terminal (the upper terminal as illustrated in FIG. 5) of the resistor 164 and a base of the transistor 165. Accordingly, the resistor 163 is connected between the emitter and the base of the transistor 165.

One terminal (the upper terminal as illustrated in FIG. 5) of the resistor 164 is connected to the other terminal (the lower terminal as illustrated in FIG. 5) of the resistor 163 and the base of the transistor 165. The other terminal (the lower terminal as illustrated in FIG. 5) of the resistor 164 is connected to the output terminal of the comparator 157 of the delay circuit 127.

The transistor 165 is a pnp-type transistor. The base of the transistor 165 is connected to the output terminal of the comparator 157 via the resistor 164. The emitter of the transistor 165 is connected to the drain of the FET 128. The collector of the transistor 165 is connected to the midpoint between the resistors 166 and 167.

The resistors 166 and 167 are connected in series with each other. One terminal (the upper terminal as illustrated in FIG. 5) of the resistor 166 is connected to the drain of the FET 128 and the emitter of the transistor 165. The other terminal (the lower terminal as illustrated in FIG. 5) of the resistor 166 is connected to the collector of the transistor 165, one terminal (the upper terminal as illustrated in FIG. 5) of the resistor 167, the other terminal (the lower terminal as illustrated in FIG. 5) of the capacitor 168 and the gate of the FET 130. The resistor 166 is connected between the emitter and the collector of the transistor 165.

One terminal (the upper terminal as illustrated in FIG. 5) of the resistor 167 is connected to the collector of the transistor 165, the other terminal (the lower terminal as illustrated in FIG. 5) of the resistor 166, the other terminal (the lower terminal as illustrated in FIG. 5) of the capacitor 168 and the gate of the FET 130. The other terminal (the lower terminal as illustrated in FIG. 5) of the resistor 167 is connected to the terminal 121B.

The midpoint between the resistors 166 and 167 is connected to the gate of the FET 130.

The capacitor 168 is connected parallel to the resistor 166. Accordingly, one terminal (the upper terminal as illustrated in FIG. 5) of the capacitor 168 is connected to one terminal (the upper terminal as illustrated in FIG. 5) of the resistor 166 and the emitter of the transistor 165. The other terminal (the lower terminal as illustrated in FIG. 5) of the capacitor 168 is connected to the midpoint between the resistors 166 and 167.

The capacitor 168 is disposed for the sake of gradually increasing the gate voltage of the FET 130 after the transistor 165 is turned off. When the H level output signal of the comparator 157 of the delay circuit 127 is input to the base of the transistor 165, the transistor 165 is turned off. Accordingly, the FET 130 is gradually turned on. As a result, the rush current flowing into the capacitor 123 and the load circuit 122 is suppressed.

When the output signal of the comparator 157 of the delay circuit 127 changes from L level to H level, the transistor 165 is turned off and the capacitor 168 is gradually charged. When the transistor 165 is turned on, the gate and the source of the FET 130 are short-circuited by the transistor 165. Thus, the FET 130 is turned off.

When the transistor 165 is turned off, charging of the capacitor 168 is started. Since the voltage of the capacitor 168 is applied between the gate and the source of the FET 130, the FET 130 is gradually turned on by the voltage of the capacitor 168 which is being charged. Accordingly, the rush current flowing into the capacitor 123 and the load circuit 122 is suppressed.

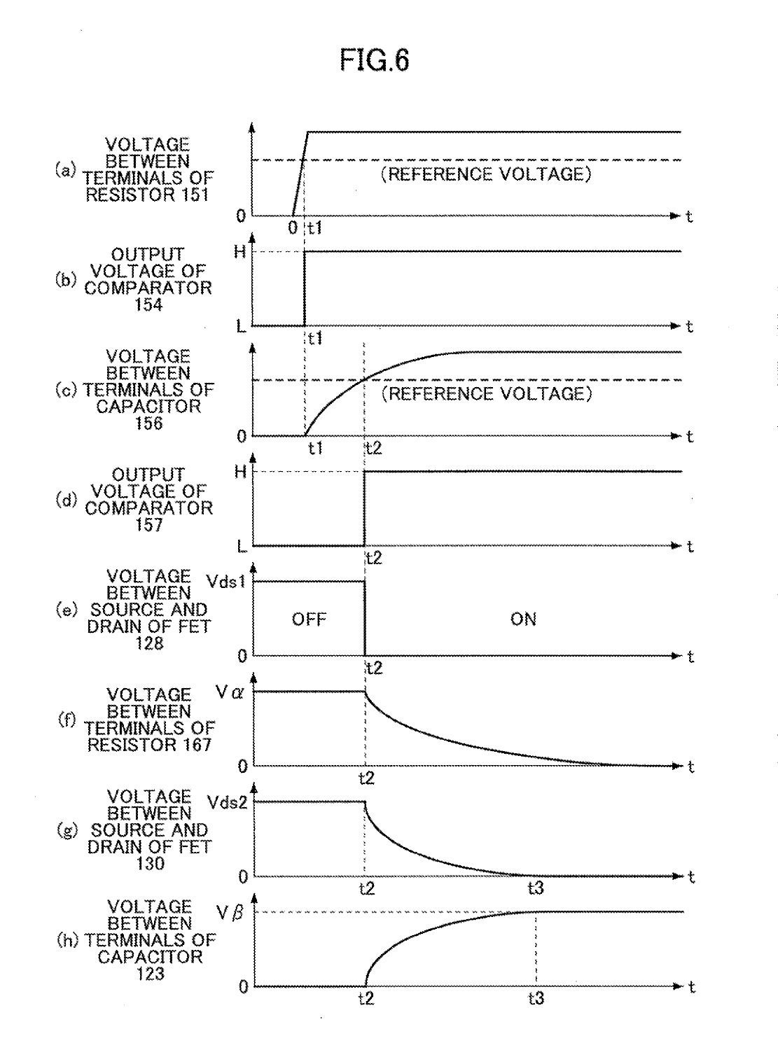

Next, behavior of the blade server 120 according to the present embodiment at the time of the hot insertion of the blade server 120 into the chassis 110 is described with reference to FIG. 6.

FIG. 6 is a time chart illustrating time evolutions of voltages of some elements included in the blade server 120 at the time of the hot insertion of the blade server 120 into the chassis 110.

FIG. 6 (a) illustrates the time evolution of the voltage between the terminals of the resistor 151. FIG. 6 (b) illustrates the time evolution of the output voltage of the comparator 154. FIG. 6 (c) illustrates the time evolution of the voltage between the terminals of the capacitor 156. FIG. 6 (d) illustrates the time evolution of the output voltage of the comparator 157.

FIG. 6 (e) illustrates the time evolution of the voltage between the source and the gate of the FET 128. FIG. 6 (f) illustrates the time evolution of the voltage between the terminals of the resistor 167. FIG. 6 (g) illustrates the time evolution of the voltage between the source and the drain of the FET 130. FIG. 6 (h) illustrates the time evolution of the voltage between the terminals of the capacitor 123.

When the terminals 121A and 121B of the blade server 120 are connected to the terminals 112A and 112B of the chassis 110 at time t=0, the voltage between the terminals 121A and 121B increases. Therefore, the voltage divided by the resistors 150 and 151 increases at time t=0.

When the voltage between the terminals of the resistor 151 exceeds the reference voltage provided by the Zener diode 153 at time t=t1 as illustrated in FIG. 6 (a), the output signal of the comparator 154 changes from L level to H level as illustrated in FIG. 6 (b).

When the output signal of the comparator 154 becomes H level, the capacitor 156 is started to be charged. Accordingly, the voltage between the terminals of the capacitor 156 begins to increase gradually from time t=t1 as illustrated in FIG. 6 (c).

When the voltage between the terminals of the capacitor 156 exceeds the reference voltage provided by the Zener diode 153 at time t=t2 as illustrated in FIG. 6 (c), the output signal of the comparator 157 changes from L level to H level as illustrated in FIG. 6 (d).

As a result, the H level output signal of the comparator 157 is delayed for a period of time t2−t1 by the capacitor 156 compared with the H level output signal of the comparator 154. Thus, the delay time applied by the delay circuit 127 is t2−t1.

When the output signal of the comparator 157 becomes H level, the transistor 160 is turned off and then the FET 128 is turned on. As a result, the voltage between the source and the drain of the FET 128 decreases from Vds1 to 0 V as illustrated in FIG. 6 (e).

Since the output signal of the comparator 157 becomes H level, the transistor 165 is turned off. Accordingly, the capacitor 168 connected between the gate and the source of the FET 130 is charged gradually. As a result, as illustrated in FIG. 6 (f), the voltage between the terminals of the resistor 167 is beginning to decrease gradually from voltage Vα at time t=t2.

As the capacitor 168 is beginning to be charged gradually, the gate voltage of the FET 130 with respect to the source voltage is beginning to decrease. Thus, the FET 130 is gradually turned on. Accordingly, the voltage between the source and the drain of the FET 130 begins to decrease gradually from voltage Vds2 at time t=t2 as illustrated in FIG. 6 (g).

As a result, the voltage between the terminals of the capacitor 123 begins to increase gradually at time t=t2 as illustrated in FIG. 6 (h) and reaches voltage Vβ at time t=t3 around when the FET 130 is completely turned on.

According to the blade server 120 of the present embodiment, the FET 128 and the FET 130 are turned off at the time of the hot insertion of the blade server 120 into the chassis 110. Accordingly, on the right side of the delay circuit 127, combined impedance of the capacitors 128A, 130A and 123 becomes larger.

The combined impedance of the capacitors 128A, 130A and 123 is larger than combined impedance of the capacitors 130A and 123 in a case where the blade server 120 does not include the FET 128.

In the blade server 120 of the present embodiment, the capacitance of the capacitor 128A is set to be a designated value so that the combined impedance of the circuit located on the right side of the delay circuit 127 at the time of the hot insertion of the blade server 120 into the chassis 110 becomes larger than impedance of the dumping circuit 125. The capacitance of the capacitor 128A represents the parasitic capacitance of the FET 128.

Accordingly, the impedance of the dumping circuit 125 is lower than the combined impedance of the capacitors 128A, 130A and 123.

Thus, it becomes possible to suppress the voltage fluctuation (resonance) by using the dumping circuit 125 in a case where the voltage fluctuation (resonance) between the terminals 121A and 121B is caused by the capacitors 128A, 130A and 123 at the time of the hot insertion of the blade server 120 into the chassis 110.

Since the impedance of the dumping circuit 125 is lower than the combined impedance of the capacitors 128A, 130A and 123, current caused by the voltage fluctuation (resonance) flows into the dumping circuit 125 rather than the circuit located on the right side of the dumping circuit 125. Thus, the current caused by the voltage fluctuation (resonance) is consumed at the resistor 142.

When the designated period of time (t2) which is provided by the delay circuit 127 elapses from time t=0, the FET 128 is turned on and the FET 130 of the rush current suppressing circuit 124 is gradually turned on. Time t=0 is the point of time when the hot insertion of the blade server 120 into the chassis 110 is performed.

As a result, when the designated period of time (t2) elapses from time t=0, the rush current flowing into the capacitor 123 and the load circuit 122 is suppressed by the FET 130 which is gradually turned on after time t=t2. Therefore the capacitor 123 is gradually charged.

Accordingly, it becomes possible to suppress the voltage fluctuation (resonance) at the time of the hot insertion of the blade server 120 into the chassis 110. Further, it becomes possible to suppress the rush current flowing into the capacitor and the load circuit 122 after the blade server 120 is installed into the chassis 110.

Thus, it becomes possible to suppress false operation or damage of the load circuit(s) 122 of other blade server (s) 120 that is (are) installed into the chassis 110 and in operation when the blade server 120 is installed into the chassis 110. Further, it becomes possible to ensure stable operation of the blade server 120 and other blade server(s) 120 after the blade server 120 is installed into the chassis 110.

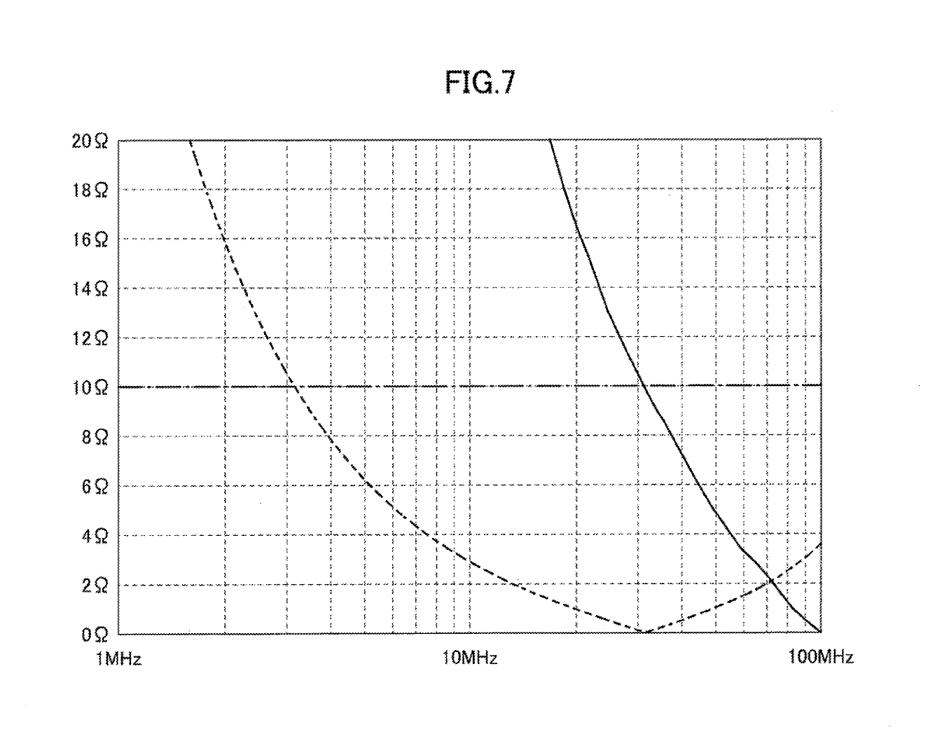

In the following, frequency characteristics of the impedance of the dumping circuit 125 and the combined impedance of the capacitors 128A, 130A and 123 will be described with reference to FIG. 7.

FIG. 7 illustrates simulation results of the frequency characteristics of the impedance of the dumping circuit 125 and the combined impedance of the capacitors 128A, 130A and 123. The simulation results are obtained by a circuit simulator such as a SPICE (Simulation Program with Integrated Circuit Emphasis).

FIG. 7 further illustrates comparative frequency characteristics of the combined impedance of the capacitors 130A and 123 of a comparative blade server which has similar configuration to the blade server 120 except for the FET 128. The comparative blade server does not include the FET 128.

In FIG. 7, a solid line indicates the frequency characteristics of the combined impedance of the capacitors 128A, 130A and 123, a dashed line indicates the comparative frequency characteristics of the combined impedance of the capacitors 130A and 123, and an alternate long and short dashed line indicates the frequency characteristics of the impedance of the dumping circuit 125.

In FIG. 7, the horizontal axis indicates frequency (MHz) and the vertical axis indicates impedance (Ω). FIG. 7 indicates the frequency characteristics in a single logarithmic chart in which the horizontal axis indicates the frequency in logarithmic form. In simulations, frequency range is set from 1 MHz to 100 MHz, and impedance range is set from 0Ω to 20 Ω.

The simulation results as illustrated in FIG. 7 are obtained in a condition where the inductance of the parasitic inductor 113A of the wirings 113 is 100 nH and the resistance of the resistor 113B is 10 mΩ.

The frequency characteristics of the combined impedance of the capacitors 128A, 130A and 123 are obtained in a condition where the capacitance of the capacitor 128A is 500 pF, the capacitance of the capacitor 130A is 5000 pF and the capacitance of the capacitor 123 is 100 pF.

The comparative frequency characteristics as illustrated in the dashed line are obtained in a condition where the capacitance of the capacitor 130A is 5000 pF and the capacitance of the capacitor 123 is 100 μF. The comparative frequency characteristics are obtained by the comparative blade server which is obtained by removing the FET 128 which includes the parasitic capacitance represented by the capacitor 128A from the blade server 120 of the present embodiment.

The frequency characteristics of the impedance of the dumping circuit 125 are obtained in a condition where the capacitance of the capacitor 141 is 1 μF and the resistance of the resistor 142 is 10Ω.

As illustrated by the solid line in FIG. 7, the combined impedance of the capacitors 128A, 130A and 123 is about 20Ω at about 15 MHz, and decreases with the increase of the frequency. The combined impedance is about 0Ω at about 100 MHz.

As illustrated by the dashed line in FIG. 7, the combined impedance of the comparative blade server is about 20Ω at about 5 MHz, and decreases to about 0Ω at about 32 MHz with increase of the frequency. Then the combined impedance increases again to about 3.5Ω at about 100 MHz with the increase of the frequency.

By comparing the frequency characteristics of the combined impedances indicated by the solid line and the dashed line, it is clear that the combined impedance is greatly increased by inserting the FET 128 which includes the parasitic capacitance represented as the capacitor 128A.

Herein, the impedance of the dumping circuit 125 is almost constant at about 10Ω.

As illustrated in FIG. 7, the combined impedance of the capacitors 128A, 130A and 123 is greater than that of the dumping circuit 125 in a wide range of the frequency from 1 MHz to about 32 MHz.

On the contrary, the combined impedance of the capacitors 130A and 123 of the comparative blade server is greater than that of the dumping circuit 125 in a narrower range of the frequency from 1 MHz to 3.2 MHz.

For example, as the length of the wirings 113 becomes shorter by the downsizing of the chassis 110, the inductance of the parasitic inductor 113A becomes smaller. As a result, frequency of voltage resonance which is caused by the parasitic inductor 113A and the parasitic capacitance included in the blade server 120 becomes higher.

Since there is an increasing trend of downsizing of the chassis 110, there is a tendency that the inductance of the parasitic inductor 113A is decreasing and the frequency of the resonance is increasing.

If the impedance of the dumping circuit 125 is greater than the combined impedance of the circuit located on the right side of the delay circuit 127, it becomes difficult to buffer the voltage fluctuation (resonance) which occurs between the terminals 121A and 121B of the blade server 120 which is installed into the chassis 110 by the hot insertion. This is because the electric power of the resonance is supplied to the capacitors 128A, 130A and 123 and the voltage fluctuation (resonance) occurs in the blade server 120 which is installed into the chassis 110.

In such a case, the voltage fluctuation may propagate to other blade server(s) 120 that is (are) installed into the chassis 110, and false operation or damage of the load circuit 122 of other blade server(s) 120 may occur.

As illustrated by the dashed line in FIG. 7, the combined impedance of the capacitors 130A and 123 becomes smaller than the impedance of the dumping circuit 125, if the frequency of the resonance becomes greater than about 3.2 MHz. Thus, when the comparative blade server is installed into the chassis 110 by the hot insertion, and if the frequency of the resonance becomes greater than about 3.2 MHz, the voltage fluctuation (resonance) becomes larger as the frequency of the resonance becomes higher.

On the contrary, according to the blade server 120 of the present embodiment, the combined impedance of the capacitors 128A, 130A and 123 is greater than the impedance of the dumping circuit 125 in a range of the frequency from 1 MHz to about 32 MHz as illustrated by the solid line in FIG. 7.

According to the blade server 120 of the present embodiment, the voltage fluctuation (resonance) between the terminals 121A and 121B is suppressed at the time of the hot insertion of the blade server 120 into the chassis 110, if the resonance frequency is lower than about 32 MHz. This means that the blade server 120 of the present embodiment has a frequency margin that is ten times larger than that of the comparative blade server which does not include the FET 128.

According to the blade server 120 of the present embodiment, it becomes possible to suppress occurrence of the voltage fluctuation (resonance) at the time of the hot insertion of the blade server 120 into the chassis 110, even though the chassis 110 is downsized and the wirings 113 are shortened.

The frequency margin which is ten times larger than that of the comparative blade server as described above is realized by making the capacitance of the capacitor 128A of the FET 128 one-tenth of that of the capacitor 130A of the FET 130.

The capacitance of the capacitor 130A is much smaller than that of the capacitor 123. The capacitance of the capacitor 128A is one-tenth of the capacitance of the capacitor 130A.

Accordingly, the combined impedance of the circuit located on the right side of the delay circuit 127 is mainly determined by the capacitance of the capacitor 128A which is smaller than that of the capacitor 130A.

Thus, it becomes possible to make combined capacitance of the capacitors 128A and 130A by making the capacitance of the capacitor 128A of the FET 128 one-tenth of that of the capacitor 130A of the FET 130. As a result, it is possible to make the frequency margin of the blade server 120 ten times larger than that of the comparative blade server which does not include the FET 128.

It becomes possible to provide the blade server 120 which suppresses the voltage fluctuation (resonance) at the time of the hot insertion of the blade server 120 into the chassis 110 by setting the size of the FET 128 in accordance with the length of the wirings 113 which is shortened by downsizing of the chassis 110.

Although it is preferable that the capacitance of the capacitor 128A is smaller than that of the capacitor 130A, it is not always necessary to make the capacitance of the capacitor 128A smaller than that of the capacitor 130A.

The capacitance of the capacitor 128A may be greater than that of the capacitor 130A as long as the combined impedance of the capacitors 128A, 130A and 123 becomes smaller than the combined impedance of the capacitors 130A and 123. Therefore, the capacitance of the capacitor 128A may be greater than that of the capacitance 130A as long as it is possible to suppress the voltage fluctuation (resonance) between the terminals 121A and 121B.

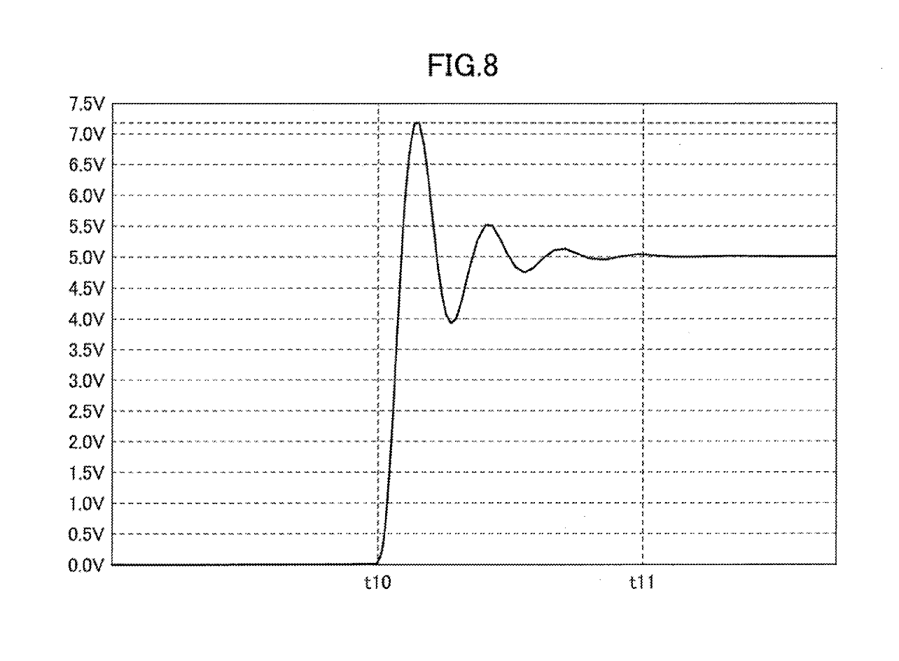

In the following, the voltage fluctuation (resonance) which occurs between the terminals 121A and 121B of the comparative blade server at the time of the hot insertion of the comparative blade server into the chassis 110 by referring to FIG. 8. The comparative blade server has a similar configuration to that of the blade server 120 except for the FET 128. The comparative blade server does not include the FET 128.

FIG. 8 is a diagram illustrating a time evolution of the voltage fluctuation (resonance) characteristics of the comparative blade server.

The characteristics as illustrated in FIG. 8 are obtained in a condition where the inductance of the parasitic inductor 113A is 100 nH, the resistance of the resistor 113B is 10 mΩ, the capacitance of the capacitor 130A is 5000 pF and the capacitance of the capacitor 123 is 100 μF.

Voltage of the direct current voltage which is supplied between the terminals 121A and 121B is 5.0 V which is equal to the rated voltage of the comparative blade server. The direct current is supplied from the terminals 112A and 112B of the chassis 110 to the terminals 121A and 121B.

As illustrated in FIG. 8, the voltage fluctuation occurs at time t=t10 when the comparative blade server is being installed into the chassis 110, and the voltage between the terminals 121A and 121B increases up to about 7.2 V at most. The resonance continues for a while and converges to 5.0 V at time t=t11. A period of time from time t=t10 to time t=t11 is 0.55 μs.

If the voltage fluctuation (resonance) such as above occurs, the voltage between the terminals 121A and 121B largely exceeds the rated voltage of the comparative blade server. As a result, the false operation or the damage of the load circuit 122 may occur.

On the contrary, according to the blade server 120 of the present embodiment, it is possible to make the combined impedance of the circuit located on the right side of the delay circuit 127 larger than the impedance of the dumping circuit 125 at the time of the hot insertion of the blade server 120 into the chassis 110, by adding the FET 128 having the capacitor 128A.

Thus, according to the blade server 120 of the present embodiment, it becomes possible to effectively suppress the voltage fluctuation (resonance) at the time of the hot insertion of the blade server 120 into the chassis 110.

Since the blade server 120 gradually turns on the FET 130 of the rush current suppressing circuit 124 after suppressing the voltage fluctuation, it is possible to suppress the rush current flowing into the capacitor 123 and the load circuit 122.

Thus, it becomes possible to suppress false operation or damage of the load circuit(s) 122 of other blade server (s) 120 that is (are) installed into the chassis 110 and in operation when the blade server 120 is being installed into the chassis 110. Further, it becomes possible to ensure stable operation of the blade server 120 and other blade server(s) 120 after the blade server 120 is installed into the chassis 110.

Since the voltage fluctuation (resonance) converges within about 0.5 μs as illustrated in FIG. 8, the delay time of the delay circuit 127 may be set to about 0.5 μs.

According to the comparative blade server, it may not be easy to set the impedance of the dumping circuit 125. According to the blade server 120 of the present embodiment, since the combined impedance of the circuit located on the right side of the delay circuit 127 is increased by adding the FET 128 having the capacitor 128A into the circuit, it becomes easier to set the impedance of the dumping circuit 125 than the comparative blade server.

According to the blade server 120 of the present embodiment, it becomes possible to suppress the voltage fluctuation (resonance) and the rush current flowing into the capacitor 123 by adding the FET 128 and without using elements having high withstand voltage.

Since it is not necessary to use the elements having high withstand voltage, it becomes possible to lower manufacturing cost of the blade server 120.

Since it is not necessary to use the elements having high withstand voltage, the blade server 120 can include a highly miniaturized integrated circuit as the load circuit 122. Thus, it becomes possible to enhance performances of the blade server 120 and the server 100.

According to the blade server 120 of the present embodiment, it is not necessary to increase resistance components thereof and to add a resistor and a switch which bypasses the resistor. Accordingly, it becomes possible to suppress increase of power consumption, voltage drop or the like, and to suppress the voltage fluctuation (resonance) effectively.

Although the embodiment in which the blade servers 120-1 to 120-N have the same configurations is described above, the configurations of the blade servers 120-1 to 120-N may be different. For example, processing speed or capacities of internal memories of the load circuits 122-1 to 122-N may be different.

The capacitances of the capacitors 141 and the resistances of the of the resistors 142 of the dumping circuits 125-1 to 125-N may be different.

The capacitances of the capacitors 128A of the FETs 128-1 to 128-N may be different. In this case, the capacitances of the capacitors 128A may be set by arranging the sizes of the FETs 128-1 to 128-N different.

Although, PMOSFETs are used as the FETs 128-1 to 128-N, NMOSFETs may be used as the FETs 128-1 to 128-N. In this case, the gate voltage of the NMOSFETs is inverted compared with that of the PMOSFETs.

Although, pnp-type transistors are used as transistors 160 and 165, npn-type transistors may be used as transistors 160 and 165.

So far, the preferred embodiments and modification of the information processing unit and the information processing apparatus are described. However, the invention is not limited to those specifically described embodiments and the modification thereof, and various modifications and alteration may be made within the scope of the inventions described in the claims.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of superiority or inferiority of the invention.

Although the embodiments of the present invention have been described in detail, it should be understood that the various changes, substitutions, and alterations could be made hereto without departing from the spirit and scope of the invention.

What is claimed is:

1. An information processing unit comprising:
a load circuit;
a pair of terminals that are capable of being connected to and removed from a direct current power source;
a first capacitor configured to be connected between power terminals of the load circuit;
a rush current suppressing circuit configured to suppress rush current flowing from the direct current power source to the first capacitor or the load circuit via the pair of the terminals;
a buffer circuit configured to be connected between the pair of the terminals and to buffer voltage fluctuation between the pair of the terminals;
a second capacitor configured to be connected in series with the rush current suppressing circuit and the first capacitor in a line parallel to the buffer circuit;
a switch configured to be connected parallel to the second capacitor; and
a first controller configured to turn on the switch when a designated period of time is elapsed after hot insertion of the pair of the terminals into the direct current power source.

2. The information processing unit as claimed in claim 1, the first controller including:
a voltage detecting part configured to output a detection signal indicating increase of voltage when detecting that voltage between the pair of the terminals is increased to a designated voltage; and
a delay part configured to delay the detection signal for the designated period of time and to output the delayed detection signal,
wherein the switch is turned on by the delayed detection signal.

3. The information processing unit as claimed in claim 2, the rush current suppressing circuit including:
a first field effect transistor configured to be connected in series with the first capacitor and the second capacitor in the line parallel to the buffer circuit; and
a second controller configured to control turning on and off of the first field effect transistor,
wherein the second controller gradually turns on the first field effect transistor when receiving the delayed detected signal from the delay part.

4. The information processing unit as claimed in claim 1, wherein the switch is a second field effect transistor, and wherein the second capacitor is parasitic capacitance between a current input terminal and a current output terminal of the second field effect transistor.

5. An information processing apparatus comprising:
plural of the information processing units as claimed in claim 1, and
a chassis configured to include plural pairs of connecting terminals, each pair of the connecting terminals being connected with the pair of the terminals of the information processing unit.
